(19) United States
(12) Patent Application Publication
(10) Pub. No.: US 2025/0125102 A1
(43) Pub. Date: Apr. 17, 2025

(54) ELBOW CHANNEL FOR A CUT-OFF CHAMBER OF A SWITCH

(71) Applicant: SAFRAN ELECTRICAL & POWER, BLAGNAC (FR)

(72) Inventors: Kévin ENOUF, MOISSY CRAMAYEL (FR); Guillaume PRIEUR, MOISSY CRAMAYEL (FR); Alexis SCHACH, MOISSY CRAMAYEL (FR); Cecil BELTAN, MOISSY CRAMAYEL (FR)

(21) Appl. No.: 18/689,581

(22) PCT Filed: Sep. 5, 2022
(86) PCT No.: PCT/FR2022/051666

§ 371 Date: Mar. 6, 2024

(30) Foreign Application Priority Data
Sep. 6, 2021 (FR) 2109313

(51) Int. Cl. H01H 9/34; H01H 33/53; H01H 71/02

(52) U.S. Cl. CPC H01H 9/342; H01H 9/346; H01H 33/53; H01H 71/025

(57) ABSTRACT

A switch includes a cut-off chamber including a contact of the switch and a fluid outlet, a channel including an inlet open on the fluid outlet of the cut-off chamber, an outlet, a fluid outlet circuit formed by the channel and the cut-off chamber, wherein the channel is elbow-shaped and includes at least two elbow ducts dividing a flow of the fluid by partitions.

### TECHNICAL FIELD OF THE INVENTION

The technical field of the invention is that of switches having a cut-off chamber and a channel.

The present invention relates to a switch comprising a cut-off chamber and a channel. More particularly, the invention relates to a switch comprising an elbow channel.

### TECHNOLOGICAL BACKGROUND OF THE INVENTION

A cut-off chamber typically comprises an electrical contact comprising a fixed contact zone and a movable contact zone. The fixed and movable contact zones are in physical and electrical contact with each other when a power circuit is to be powered. When it is desired to interrupt the power circuit, the movable contact zones and the fixed contact zones are separated. During the separation of the contact zones, the movable contact zone that was under pressure on the fixed contact zone to allow the current to flow, moves away and an electric arc is created in the air. The electric arc generates gases that cause a significant increase in heat as well as an increase in pressure in the cut-off chamber. This overpressure, if not released outside the switch, limits the electrical breaking power of the switch by a choking effect. In addition, particles from the degradation of the electrical contact zones are created during arc formation. These particles of varying sizes must not be projected towards other equipment near the switch which would be damaged as a result.

There are several types of arrangement of a cut-off chamber of an electrical switch.

A first type of arrangement is a hermetic cut-off chamber. This type of arrangement is particularly suitable for compact switches because the switching capacity of these switches is limited. In addition, hermeticity requires technical parts with a specific implementation. In the aeronautical industry, the hidden failure of an insulating gas leak is a major disadvantage for an electrical protection system.

A second type of arrangement is an entirely open chamber. The electric arc projections are sent outside the cut-off chamber and an exclusion zone is defined around the switch wherein no sensitive equipment may be installed. Therefore, a box around the switch is recommended. This solution is of large size (buck) because the exclusion zone needs to be large, so this solution is not suitable for applications that require a small size, such as switches in the aeronautical field.

A third type of arrangement is a cut-off chamber having a right channel also known as lateral with respect to the cut-off chamber, which may comprise a filter being face to face the chamber outlet. The right channel is therefore perpendicular to the axis of movement of the mobile contact or/and in the same direction as the plane of the cut-off blades of a blade block. The right channel therefore comprises an inlet and an outlet opposite the chamber outlet of the switch to allow having an exhaust gas flow along a right axis requiring a free lateral exhaust volume face to face the outlet of the channel to allow the gas to escape. However, in some configurations, such switches may not be installed because the total side dimension (switch+free side volume included) may be too large with respect to this available side dimension. The total lateral dimension of this third type of switch is therefore a disadvantage that may prevent its installation or the installation of other equipment. For example, when they are mounted on rails with other electrical equipment, this may reduce the number of pieces of equipment that may be positioned on the rail. In addition, in the case of a switch with such a right channel comprising a filter, the lateral dimension increases. In addition, with or without a filter, particles (in the case of a particle filter smaller than the filter) may exit this side outlet and be propelled directly onto other equipment.

Typically, a free exhaust volume or a receiving chamber is located at the filter outlet.

There is therefore a need to have a switch having a cut-off chamber reducing or eliminating at least one of the problems mentioned above.

### SUMMARY OF THE INVENTION

The invention offers a solution to at least one of the problems mentioned above, by making it possible to increase the travel distance of a fluid with an equivalent volume with respect to a switch comprising a non-elbow channel and thus increasing the compactness of the switch.

A first aspect of the invention relates to a switch comprising:

a cut-off chamber comprising a contact of the switch and a fluid outlet,

a channel comprising:
an inlet open on the fluid outlet of the cut-off chamber,
an outlet,

a fluid outlet circuit formed by the channel and the cut-off chamber, said channel being elbow-shaped and comprising at least one partition and two elbow ducts dividing a flow of the fluid separated by the partition, a filter in the fluid outlet circuit.

Thus, the elbow channel makes it possible to decrease the size of the switch with respect to a non-elbow channel in that the fluid travels more with an elbow channel than with a non-elbow channel. The elbow channel further makes it possible to direct the discharged fluid in a direction, thus allowing better organization of the space, indeed, it allows the fluid to be directed in a direction allowing the fluid to be received in another direction, in particular by a cover of the switch. This therefore eliminates the need for a free side exhaust volume or an additional receiving chamber, which saves space and equipment.

In addition to the characteristics that have just been mentioned in the preceding paragraph, the switch according to the invention may have one or more additional characteristics from among those mentioned in the following paragraphs, taken individually or according to any technically permissible combination.

According to one embodiment, one of the ducts is a main duct having an inlet section located face to face the contact of the switch of the cut-off chamber, the main duct having an outlet section greater than the outlet sections of the other ducts. The zone located in face the contact of the switch is the most stressed zone of the channel. Therefore, it is imperative that the most stressed zone of the switch be sent in a specific duct limiting the pressure losses.

According to one embodiment, the channel comprises two partitions and are watertight.

According to one embodiment, the path of the ducts is identical to the shape of said channel.

According to one embodiment, the inlet of the channel is rectangular, the outlet of the channel is rectangular, the channel comprises:

at least one elbow wall;

two side walls, each connecting the elbow wall and the walls of the contact chamber on either side.

According to an example of this embodiment, the two side walls are flat. According to one variant in this example, the two side walls are curved, for example concave.

According to one example of this embodiment, the two side walls are inclined with respect to each other such that the inlet of the channel comprises a section less than the outlet of the channel.

According to an example of this embodiment, each side wall comprises a first side forming the inlet of the channel and a second side forming the outlet of the channel, wherein the first side has a length greater than the second side.

According to an example of this embodiment, a first edge of the elbow wall forming the inlet of the channel is less than a second edge of the elbow wall forming the outlet of the channel.

According to one embodiment, a second edge of the elbow wall forming the outlet of the channel is greater than the first edge of the elbow wall. Thus, the outlet of the channel is flared with respect to its inlet, thus allowing for a reduction in pressure losses.

According to one embodiment, the channel is in the form of a rounded elbow. The rounding of the elbow makes it possible to reduce pressure losses.

According to one embodiment, the channel is oriented at a right angle. Orienting the channel at a right angle allows the gas flow to be directed to a suitable location. For example, the flow may be directed towards the cover of the switch, thus limiting the number of pieces of equipment and therefore not use an additional fluid receiving chamber.

According to an example of this embodiment, the filter is located at the outlet of the channel. Placing the filter at the outlet of the channel makes it possible to reduce the pressure drops. Thus the filter does not choke the fluid with respect to a filter placed at the inlet of the channel. The further the filter is placed from the contact of the switch, the less the flow of fluid will be choked.

According to another example of this embodiment, the pore size of the filter is less than 100 micrometers.

According to another example of this embodiment, the filter is made of stainless steel.

According to one embodiment, the fluid outlet of the cut-off chamber comprises a section identical to an inlet of the section of the channel.

According to one embodiment, the cut-off chamber comprises a fin block between the contact and the fluid outlet, the fin block comprises fins stacked apart from each other over an entire height of the fin block and in that the fluid outlet of the cut-off chamber has a height greater than or equal to the height of the fin block.

According to one embodiment, the channel comprises two partitions and three elbow ducts fluidly separated from each other by the partitions. For example, the main duct may be located between two other outer ducts.

According to one embodiment, the switch comprises a cover forming part of the fluid outlet circuit, comprising an inlet open on the outlet of the channel. Therefore, the installation of the switch does not require an additional free exhaust volume or fluid receiving chamber, the cover plays the role of fluid receiving.

### BRIEF DESCRIPTION OF THE FIGURES

The figures are presented for the purposes of information and in no way limit the invention.

FIG. 1 is a sectional view of a switch comprising a cut-off chamber and a channel.

FIG. 2 is a perspective view of the channel.

FIG. 3 is a top view of a part of a switch.

FIG. 4 is a sectional view of a part of FIG. 1 along section IV-IV.

### DETAILED DESCRIPTION

Unless otherwise specified, the same element appearing in different figures has a unique reference.

The invention relates to a switch comprising a cut-off chamber and a channel.

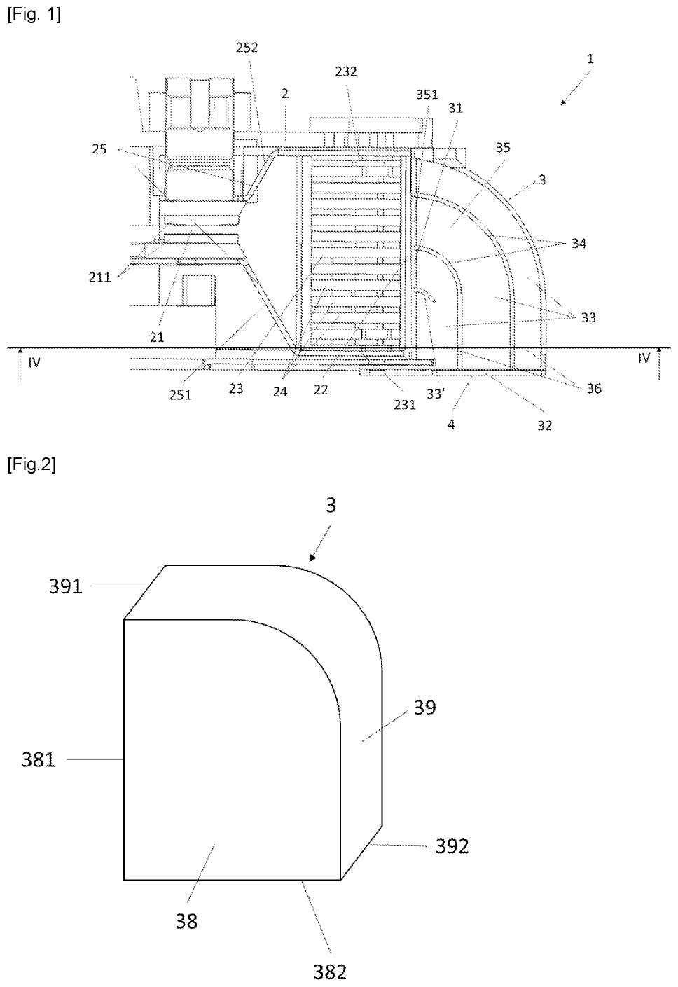

In reference to FIG. 1, according to one embodiment of the invention, a

switch 1 comprises a cut-off chamber 2 and a channel 3. The cut-off chamber 2 comprises a contact 21, a fluid outlet 22 and a fin block 23 comprising fins 24 stacked and apart from each other over an entire height of the fin block 23. The fin block 23 is located between the contact 21 and the fluid outlet 22. The contact 21 comprises two contact zones 211 facing each other. The contact 21 is in a closed state when the contact zones 211 are in contact with each other and in an open state when the contact zones 211 are separated from each other. The fins 24 enable electric arcs coming from the contact 21 to be cut when the latter changes from a closed state to an open state. The channel 3 forms a fluid outlet circuit with the cut-off chamber 2.

The cut-off chamber 2 further comprises two arc guides 25 for guiding the arcs from the contact 21 to the fin block 23. A first arc guide 251 and a second arc guide 252 are directed from the contact zones 211 to a first end 231 and a second end 232 of the fin block 23, respectively. The first end 231 is opposite the second end 232. The height of the fin block 23 is between the first end 231 and the second end 232.

The electric arcs move from the contact 21 to the fin block 23. The formation of these electric arcs causes a pressure increase in the cut-off chamber 2. If this overpressure is not released outside of the cut-off chamber 2, the latter limits the electrical cut-off power of the cut-off chamber 2 by a choking effect. The overpressure comes from a fluid comprised, among other things, of ionized gas and solid particles from the degradation of the contact 21.

Thus, the channel 3 comprises an inlet 31 and an outlet 32 the inlet 31 of which is open on the fluid outlet 22 of the cut-off chamber 2. By the inlet 31 “is open on” the fluid outlet 22, it is meant that the inlet 31 is connected to fluid outlet 22. The fluid outlet 22 of the cut-off chamber 2 comprises a section identical to the section of the inlet 31 of channel 3. The fin block 23 is face to face the fluid outlet 22.

A filter 4 is located at the outlet 32 of the channel 3, the filter 4 may therefore be located in or against the outlet 32. The filter 4 may also be located inside the channel 3, at the inlet 31 of the channel 3 or in the cut-off chamber 2.

In this example shown, the fluid coming from the cut-off chamber 2 first passes through the fluid outlet 22 of the cut-off chamber 2, then flows into the channel 3 through the inlet 31 of the channel 3 and exits from channel 3 through the outlet 32 of the channel 3.

The channel 3 is elbow-shaped and in this example is oriented at a right angle but could be oriented at an angle between 45° and 180°. A right angle is defined as an angle between 89° and 91°. The channel 3 has the shape of a rounded elbow in order to limit the pressure losses when the fluid flows in the channel 3. A section of the outlet 32 of channel 3 is oriented at a right angle with respect to the section of the inlet 31 of channel 3. Thus, the fluid will exit channel 3 in an outlet direction perpendicular to a direction of fluid entering the channel 3. The direction of the fluid entering the channel 3 is established when the fluid enters by the inlet 31 of the channel 3. The outlet direction of the fluid of the channel 3 is established when the fluid exits through the outlet 32 of the channel 3.

In this example, the section of the inlet 31 of the channel 3 is rectangular in shape. The outlet section 22 of the cut-off chamber 2 is rectangular in shape. According to another example not shown, the section of the inlet 31 of channel 3 may be round or oval in shape. Similarly, the outlet section 22 of the cut-off chamber 2 may be round or oval in shape and be different from the section of the inlet 31.

In this example, the outlet section 22 of the cut-off chamber 2 is identical to the inlet section 31 of channel 3.

In this example, the channel 3 comprises three ducts 33 dividing the flow of the fluid by watertight partitions 34. Thus, in this example, the fluid is separated in each duct 33. Thus, there is no possible fluid transfer between the ducts 33.

The inlet and outlet sections of the ducts 33 are rectangular in shape.

One of the three ducts 33 is a main duct 35. The main duct 35 comprises an inlet 351 located face to face the contact 21, i.e. a straight line perpendicular to the section of the inlet 351 of the main duct 35 extends to the contact 21. Of course, fin block 23 fins 24 are located between the contact 21 and inlet 351. The main duct 35 has its inlet 351 closest to the contact 21 with respect to the inlets of the other ducts.

The main duct 35 corresponds to the duct 33 most stressed by the increase in pressure following the appearance of arcs. Indeed, in the zone close to the contact 21, the pressure increase is greater than in the zones far from contact 21. The main duct 35 has an outlet section greater than the outlet sections of the other ducts 33 in order to reduce the pressure losses specifically for this main duct 35. The main duct 35 is located between the two other ducts 33 called outer ducts 36. The main duct 35 has a pressure loss sizing optimized to the detriment of the outer ducts 36. In this example, the watertight partitions 34 are therefore oriented so that a minimum section of the main duct 35 is equal to or similar (i.e. between 0 and −5% less surface area) to the section of the inlet 351 thus allowing to have an optimized pressure loss sizing. In particular in this example, the main duct 35 comprises a regular section along the entire length. Thus, in this example, the outer ducts 36 each have a section that decreases from the inlet to the outlet of the outer duct 36.

In another embodiment not shown, the main duct 35 is closest to a periphery of the channel 3 if, for example, the contact 21 is located closer to the periphery of the channel 3 than the center of the section of the channel 3.

The channel 3 may comprise deflectors 33′ located in the ducts 33. The role of the deflectors 33′ is to guide the fluid to the outlet 32 of the channel 3 and has a shape equivalent to the shape of the channel 3 or the shape of the watertight partitions 34. In FIG. 1, the deflector 33′ is located in the outer duct 36 closest to the first end 231 of the fin block 23. The deflector 33′ is located in the duct 33 having the largest inlet section relative to the other inlet sections of the other ducts 33. Thus, the deflector 33′ may guide the fluid exiting a duct 33 to prevent the fluid from bouncing back against the partition 34 toward the inlet 31.

In reference to FIG. 2 which is a perspective view of the channel 3, the channel 3 comprises at least one elbow wall 39 and two side walls 38 connected on either side to the elbow wall 39. Each side wall 38 is in this case flat. The two side walls 38 are furthermore in particular parallel to one another. The side walls 38 each comprise a first side 381 forming a periphery of the inlet 31 of the channel 3. The side walls 38 also comprise a second side 382 forming a periphery of the outlet 32 of the channel 3. The first side 381 of the side wall 38 has a length greater than the length of the second side 382 of the side wall 38. This feature makes the switch 1 more compact.

The first side 381 of the side wall 38 is preferably greater than or equal to the height of the fin block 23 comprised between the first end 231 and the second end 232. This allows the gas to be evacuated linearly to channel 3 during the cut-off of each arc between each pair of neighboring fins.

The elbow wall 39 comprises a first edge 391 forming the periphery of the inlet 31 of the channel 3. The elbow wall 39 also comprises a second edge 392 forming the periphery of the outlet 32 of the channel 3. The first edge 391 of the elbow wall 39 has a dimension in length identical to the second edge 392.

In another embodiment not shown, the second edge 392 of the elbow wall 39 is greater than the first edge 391 of the elbow wall 39. This embodiment allows a flaring of the outlet 32 of the channel 3 with respect to the inlet 31 of the channel 3 thus allowing a reduction of the pressure losses.

In this example shown, the watertight partitions 34 each have a shape that follows the shape of the elbow of the elbow wall 39.

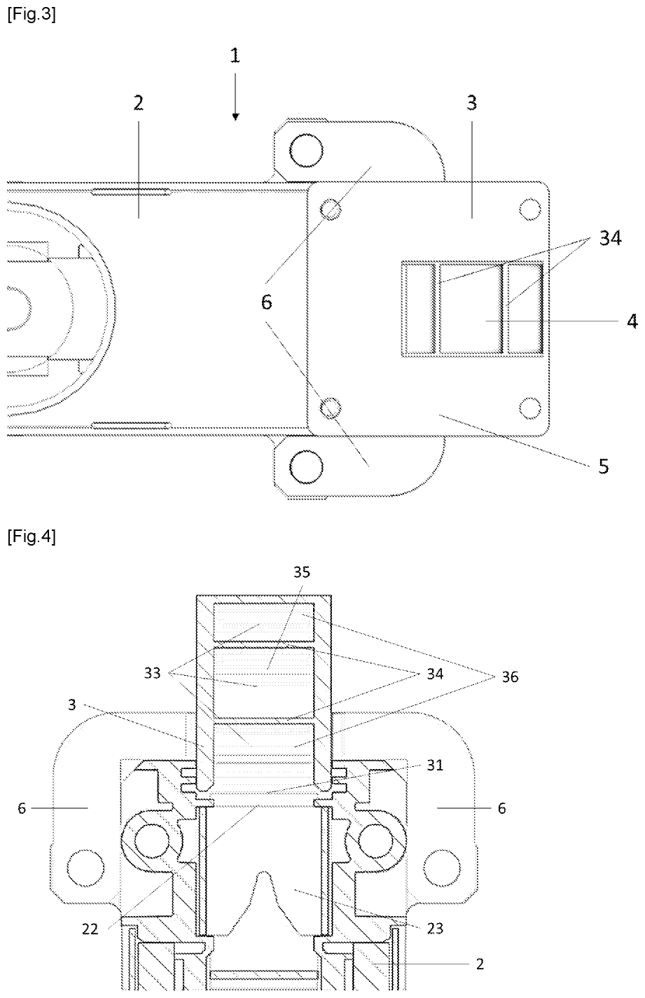

In reference to FIG. 3, the fluid exits the channel 3 through the outlet 32 of the channel and passes through the filter 4. The filter 4 comprises a section identical to the outlet section 32 of the channel 3.

A plate 5 is located at the outlet 32 of the channel 3. The filter 4 is sandwiched between the outlet 32 of the channel 3 and the plate 5. The area of plate 5 is larger than the outlet section 32 of channel 3.

By positioning the filter 4 against the outlet 32 of channel 3, it is thus placed at a sufficient distance from the cut-off chamber 2 so that the fluid has lost part of its energy in channel 3. The pore size of filter 4 may vary depending on the need. Preferably, the pore size has an average size of less than 100 micrometers. The filter 4 may be made of stainless steel. The filter 4 makes it possible to limit the particles that are ejected outside the switch 1.

The switch 1 may comprise a cover. The cover has a protective function for the switch 1. The cover is mounted on the channel 3 or the plate 5, for example. The cover further makes it possible to recover particles smaller than the pore size of the filter at the channel 3 outlet. The outlet 32 of the channel 3 is open on an inlet of the cover. The volume of the cover is therefore part of the fluid outlet circuit with the cut-off chamber 2 and the channel 3.

The switch 1 comprises two fastening arms 6 for attaching the channel 3 to a support forming the cut-off chamber or, for example, to the cover.

In reference to FIG. 4, the shape of the section of the ducts 33 is rectangular.

1. A switch comprising:
a cut-off chamber comprising a contact of the switch and a fluid outlet,
a channel comprising:
an inlet open on the fluid outlet of the cut-off chamber,
an outlet,
a fluid outlet circuit formed by the channel and the cut-off chamber, wherein said channel is elbow-shaped and comprises at least one partition and two elbow ducts dividing a flow of the fluid separated by the partition.

2. The switch according to claim 1, wherein one of the two elbow ducts is a main duct having an inlet section located face to face the contact of the switch of the cut-off chamber, the main duct has an outlet section greater than the outlet sections of the other ducts.

3. The switch according to claim 1, wherein the inlet of the channel is rectangular, the outlet of the channel is rectangular, the channel comprises:
at least one elbow wall,
two side walls, each connecting the elbow wall and the walls of the contact chamber on either side.

4. The switch according to claim 3, wherein each side wall comprises a first side forming the inlet of the channel and a second side forming the outlet of the channel, wherein the first side has a length greater than the second side.

5. The switch according to claim 1, wherein the channel has a rounded elbow shape.

6. The switch according to claim 1, wherein the channel is oriented at a right angle.

7. The switch according to claim 1, wherein the fluid outlet of the cut-off chamber comprises a section identical to an inlet of the section of the channel.

8. The switch according to claim 1, wherein the cut-off chamber comprises a fin block between the contact and the fluid outlet, the fin block comprises fins stacked apart from each other over an entire height of the fin block and in that the fluid outlet of the cut-off chamber has a height greater than or equal to the height of the fin block.

9. The switch according to claim 8, wherein the channel comprises two partitions and three elbow ducts fluidically separated from each other by the partitions.

10. The switch according to claim 1, comprising a cover forming part of the fluid outlet circuit comprising an inlet open on the outlet of the channel.

11. The switch according to claim 1, comprising a filter in the fluid outlet circuit.
